(19) United States
(12) Patent Application Publication
(10) Pub. No.: US 2008/0155501 A1
(43) Pub. Date: Jun. 26, 2008

(54) System and Method for Revising an Electronic Draft

(76) Inventors: Frederick Rajendran Ravikumar, Bangalore Karnataka (IN); Thirumalaiswamy Subramaniam, Bangalore Karnataka (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/816,530

(22) PCT Filed: Mar. 3, 2005
(86) PCT No.: PCT/IN05/00068

§ 371 Date: Aug. 17, 2007

(51) Int. Cl. G06F 9/44

(52) U.S. Cl. 717/110

(57) ABSTRACT

Disclosed is a system for revising an electronic draft having a first format. This system includes an extraction unit adapted to extract a part of the data of the electronic draft requiring revision, a transformation unit adapted to transform the extracted data into a second format, a first transmitting unit adapted to transmit the transformed extracted data to a first viewing unit, wherein the first viewing unit is adapted to display the transformed extracted data and an input unit adapted to receive revising input for revising the displayed transformed extracted data. The system further includes an editing unit adapted to edit the transformed extracted data according to the revising input and a second transmitting unit adapted to transmit the edited transformed extracted data to a second viewing unit wherein the second viewing unit is adapted to display edited transformed extracted data wherein the first format is adapted such that the electronic draft can not be edited using the editing unit.

### BACKGROUND

The invention relates generally to electronic media and more particularly to a system and method for revising an electronic draft.

In a world where companies and people are spread out across different countries, in terms of distance and time zone, electronic data exchange has become the primary communication media. Data files are exchanged between managers and partners like customers and suppliers for review.

For example, a first company in one part of the world has the task to design and program a website for a second company in another part of the world. Accordingly, the first company makes a draft and sends it to the second company for review. After having reviewed the draft, the second company sends the reviewed draft back to the first company having included specifications for changes on the draft. The process of bringing the website to its final form may include several iterations of sending a draft and sending a reviewed draft back. This is typically done electronically.

The reviewing or revising of a draft is typically done in the following way: a reviewer uses some application to view the draft, in the case of a website typically using a browser software, like Microsoft Internet Explorer or Netscape. When the reviewer wants to include specifications for changes that he wishes to be done he generates a screen capture to generate an image of the corresponding portion of the draft and exports the image to another software, typically Microsoft Word or Microsoft Power Point. By using the features provided by the software, the reviewer includes the changes that he wishes to be done and highlights them using the available format options.

This process has typically to be repeated for multiple screens. A website, for example, typically includes many web pages.

FIG. 1 shows an example for reviewers' comments according to prior art.

In this example, a reviewer has made a screen capture of one page of a website, printed it, specified by hand the changes he wishes to be done to the draft and scanned the printout including the specifications.

Alternative to printing, specifying the changes by hand and rescanning, the reviewer could have used some software, for example Microsoft Word, to specify the changes he wishes to be done. However, this is also complicated. For example, it is difficult to cross something out using Microsoft Word.

Using the above process, a huge amount of data is generated. Screen captures and scans of printed pages are huge data files, which, even after compressing them, consume a lot of disc space. Further, since the review draft has to be sent back to the drafter, this leads to heavy traffic on the communication network resulting in long waiting time for the users. Screen captures also result in high usage of computer memory and computer processing power for handling the huge data files.

Additionally, reviews of drafts created in the above way are not easily understandable. Like illustrated in FIG. 1, the review includes pages where something is crossed out, something is written in some corner of the pages, etc. Therefore, it is not unusual that the drafter to which the reviewed draft is sent does not understand what changes the reviewer wishes to be done. This leads to the exchange of more emails for clarification, multiple telephone calls, or conferences which is cumbersome and results in productivity loss.

The drafter typically receives reviews from different reviewers and after he has analysed all the required changes from the different reviewers and having understood the changes, has to incorporate all changes according to the requirements into the draft. This is a tedious comparison process. For example, the drafter prints out all the reviews, compares them, uses the application used for creating the draft and incorporates all the necessary changes. Alternatively, if the changes which should be done are included in the draft in some amending mode (if for example the draft was written in Microsoft Word and the changes are indicated), the drafter has to track the changes carried out by all reviewers and accept or reject them accordingly. In this case, however, it is necessary that the reviewers have a license of the corresponding application (for example Microsoft Word).

If the draft has been created using an application which is not commonly owned (or licensed) by a lot of people, for example a professional CAD (computer aided design) software, the reviewers still have to make printouts or screen captures. All in all, the above described reviewing method is tedious and time consuming. Furthermore, it is extremely difficult for reviewers to provide thoughts or feedback to the draft in an effective manner. What is needed is a system and a method for reviewing an electronic draft more easily, efficiently and conveniently than the system known so far.

### SUMMARY

An embodiment of the invention includes a system for revising an electronic draft having a first format. This system includes an extraction unit adapted to extract a part of the data of the electronic draft requiring revision, a transformation unit adapted to transform the extracted data into a second format, a first transmitting unit adapted to transmit the transformed extracted data to a first viewing unit, wherein the first viewing unit is adapted to display the transformed extracted data and an input unit adapted to receive revising input for revising the displayed transformed extracted data. The system further includes an editing unit adapted to edit the transformed extracted data according to the revising input and a second transmitting unit adapted to transmit the edited transformed extracted data to a second viewing unit wherein the second viewing unit is adapted to display edited transformed extracted data wherein the first format is adapted such that the electronic draft can not be edited using the editing unit.

These and other features of the invention will be better understood in light of the following drawings and detailed description.

### BRIEF DESCRIPTION OF THE DRAWINGS

FIG. 1 shows an example for reviewers' comments according to prior art.

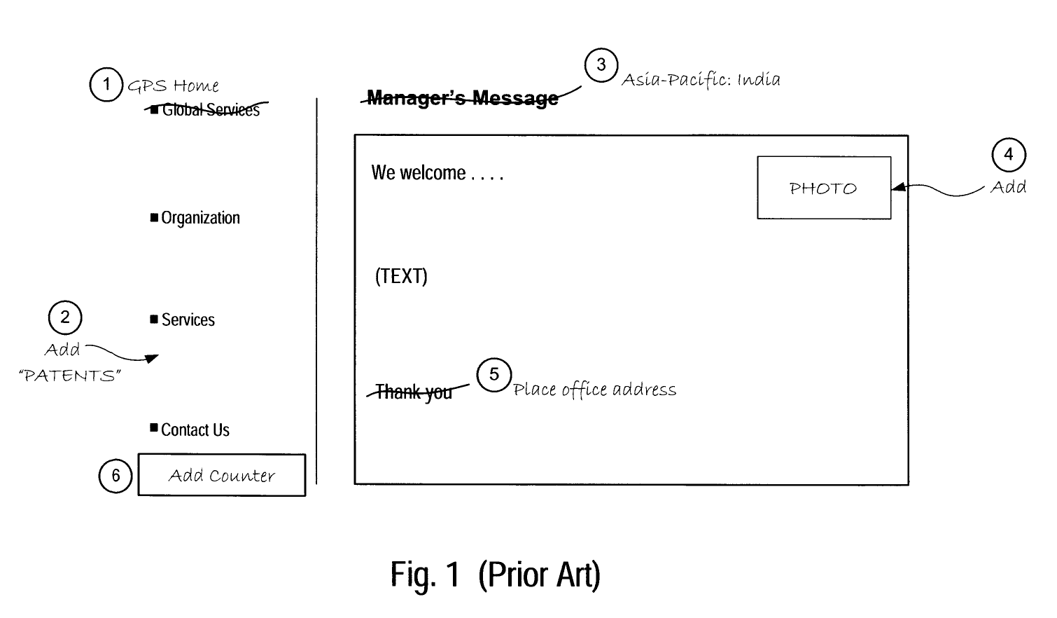

FIG. 2 shows a system for revising an electronic draft according to an embodiment.

FIG. 3 shows a flowchart of a method for revising an electronic draft according to an embodiment.

FIG. 4 shows a system for revising an electronic draft according to an embodiment.

FIG. 5 shows a system according to an embodiment.

FIG. 6 shows a flow diagram according to an embodiment.

FIG. 7 shows a block diagram illustrating a reviewing software architecture according to an embodiment.

FIG. 8 shows a graphical user interface of an underlying application creating program according to an embodiment.

FIG. 9 shows a review-able item according to an embodiment.

FIG. 10 shows a modified review-able item according to an embodiment.

FIG. 11 shows a modified review-able item according to an embodiment.

FIG. 12 shows a flow diagram according to an embodiment.

### DETAILED DESCRIPTION

The invention provides a system and a method for revising an electronic draft, computer systems, computer program elements and computer readable media according to the system for revising an electronic draft.

Illustratively, for revising a draft which was created using a certain software, the parts of the draft which need to be revised are extracted from the draft using a format that is different from the format of the draft and the parts are transmitted to the reviewers' computer systems. Since the parts have been transformed into a format different from the format of the draft, the software with which the draft was created does not need to be available on the reviewers' computer systems. The parts of the draft can then be edited and/or commented and the edited and/or commented parts are sent back to the drafter's computer system, where they are displayed.

Therefore, the reviewers can revise the draft (include suggested changes and/or updates) in an easy way even in the case where the software with which the draft was created is not owned. In particular, the reviewers do not need to export parts of the draft into other applications (e.g. make screenshots), print parts of the draft and/or rescan edited parts of the draft. The reviewing process is therefore significantly accelerated.

According to one embodiment the draft's format, i.e. the first format, is a format for which corresponding editing software is not commonly available, for example the format of an Adobe Acrobat document, an AutoCad file format (or another CAD software format), e.g. generally a file format of a non-Microsoft application, a web-based format e.g. asp (active server pages) format or html (hyper text markup language) or any other format according to some “web” application or “desktop” application.

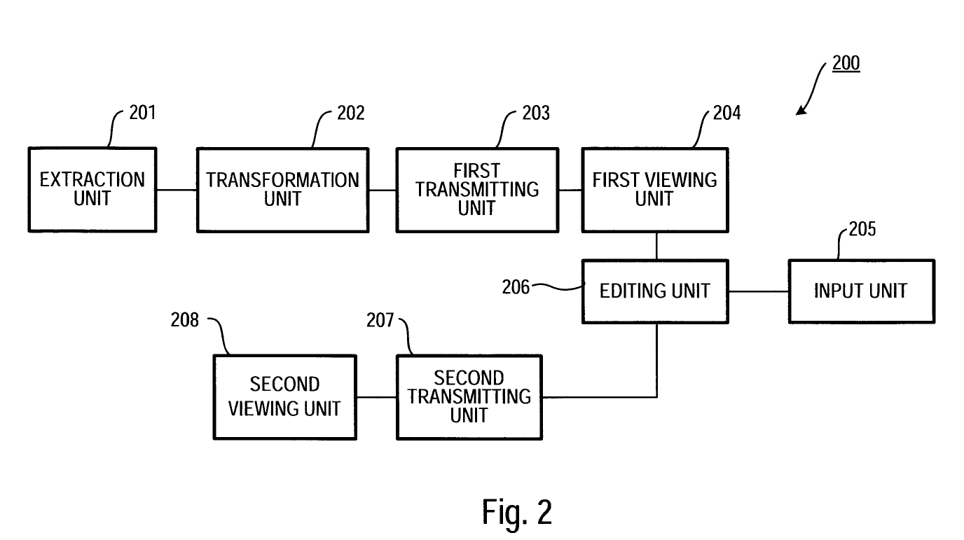

FIG. 2 shows a system for revising an electronic draft 200 according to an embodiment. The system for revising an electronic draft 200 includes an extraction unit 201 adapted to extract a part of the data of the electronic draft requiring revision and a transformation unit 202 adapted to transform the extracted data into a second format.

The system for revising an electronic draft 200 further includes a first transmitting unit 203 adapted to transmit the transformed extracted data to a first viewing unit 204, wherein the first viewing unit is adapted to display the transformed extracted data. Further the system for revising an electronic draft 200 includes an input unit 205 adapted to receive revising input for revising the displayed transformed extracted data and an editing unit 206 adapted to edit the transformed extracted data according to the revising input. A second transmitting unit 207 is adapted to transmit the edited transformed extracted data to a second viewing unit 208 which is adapted to display the edited transformed extracted data.

The transformed extracted data corresponds to a portion of the draft and can be edited using revising input. For example, passages of the portion of the draft can be highlighted (or other special effects can be included), text and/or graphics can be included into the portion of the draft etc. Thus, the reviewers can comfortably provide feedback using various tools.

The editing (i.e. the changes) of the transformed extracted data can also be tracked and the editing information can be stored in the edited transformed extracted data. In one embodiment, the tracked changes can be easily browsed, e.g. by clicking a “previous” button, a “next” button, a “first” button, and/or a “last” button provided by a graphical user interface, thus navigating through the tracked changes accordingly. On a computer system of the reviewer, e.g. a Microsoft Windows platform, the edited transformed extracted data is for example saved in a file different from the file containing the transformed extracted data (e.g. with a different file extension).

The system for revising an electronic draft 200 can for example be realized using a Microsoft operating system or a non-Microsoft operating system (e.g. an open operating system like Linux), in particular a pocket version operating system for a hand-held personal computer or a pocket personal computer (Pocket PC). For a mobile computer system such as a Pocket PC, the functionality may be somewhat limited due to the limitations of available memory, java runtime availability or email support.

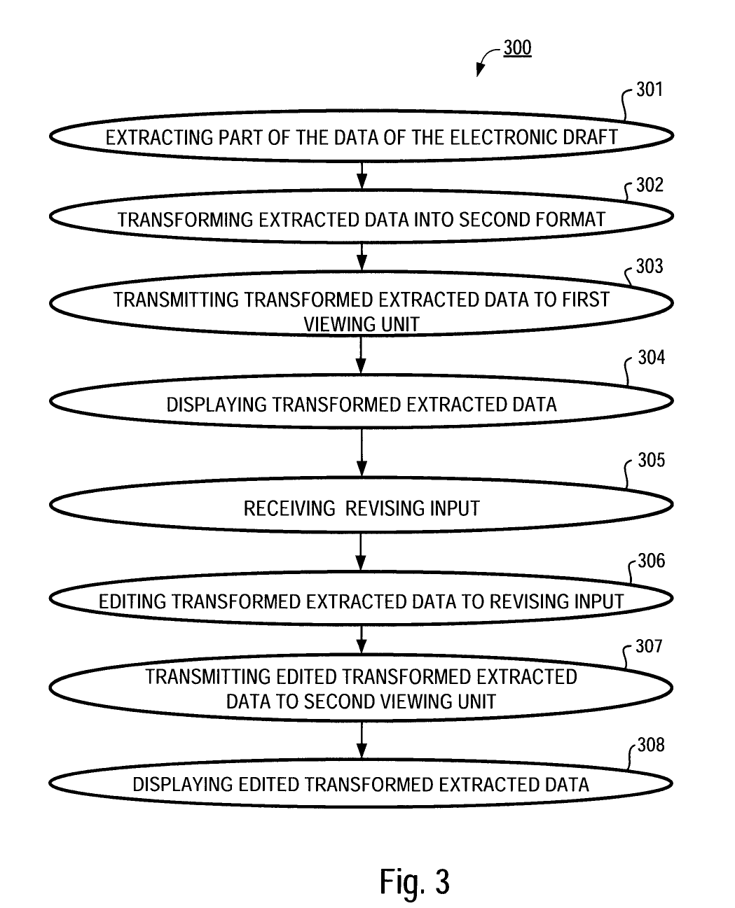

FIG. 3 shows a flowchart 300 of a method for revising an electronic draft according to an embodiment. In step 301, a part of the data of the electronic draft to be revised is extracted. In step 302, the extracted data is transformed into a second format. In step 303, the transformed extracted data is transmitted to a first viewing unit. After that, the transformed extracted data is displayed in step 304. In step 305, revising input for revising the displayed transformed extracted data is received. According to the revising input, the transformed extracted data is edited by an editing unit in step 306. In step 307, the edited transformed extracted data is transmitted to a second viewing unit. In step 308, the edited transformed extracted data is displayed.

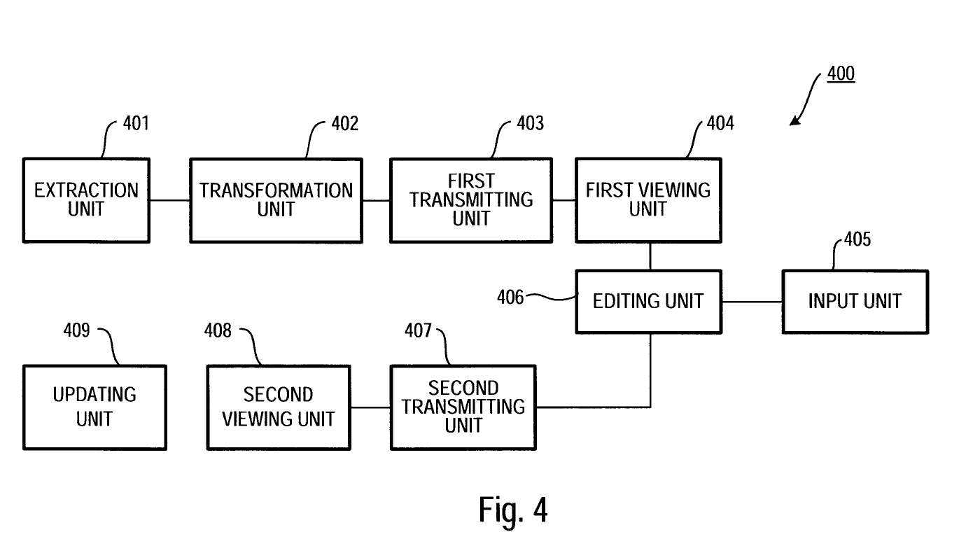

The embodiments which are described in the context of the system for revising an electronic draft are analogously valid for the method for revising an electronic draft, the computer systems, the computer program elements and the computer readable media. FIG. 4 shows a system for revising an electronic draft 400 according to an embodiment.

Similar the system for revising an electronic draft 200 shown in FIG. 2, the system for revising an electronic draft 400 includes an extraction unit 401, a transformation unit 402, a first transmitting unit 403 adapted to transmit the transformed extracted data to a first viewing unit 404, an input unit 405, an editing unit 406 adapted to edit the transformed extracted data according to the revising input, a second transmitting unit 407 and a second viewing unit 408 which have the same functionality as described above with reference to FIG. 2.

The system for revising an electronic draft 400 further includes an updating unit 409 adapted to update the electronic draft according to the revised portion of the electronic draft using the edited transformed extracted data. This enables the drafter (who may also be responsible for updating the draft according to the feedback) to easily incorporate changes and/or updates provided by the reviewers into the draft. For example, the drafter (author of the draft) can accept and/or reject changes suggested by the reviewers and incorporate the accepted changes by clicking a button provided by a graphical user interface. In particular, the drafter benefits from the possibility of merging and consolidating multiple feedbacks from different reviewers and from the possibility of updating the feedback provided by the reviewers into the draft. Alternatively, the author can import the suggested changes into the draft manually, e.g. by opening the draft with the software with which the draft was created.

Again with reference to FIG. 2 the extraction unit 201 may be a plug-in of a computer program with which the electronic draft can be edited and/or created and/or viewed. For example, the extraction unit 201 may be realized by a plug-in of Microsoft Excel which can export a portions of a Microsoft Excel file into XML (extended markup language) or CSV (Comma Separated Values) format.

Using plug-ins allows a modular structure of the system for revising an electronic draft 200. Complexities of the format of a draft created with one software (such as a complicated CAD software) can be handled by the corresponding plug-in and do not need to be considered in other parts of the system. Further, the first viewing unit 204 may have a modular structure and may for example include a dedicated editor for handling CAD drawings (and for displaying CAD drawings in a commonly used form).

The plug-in may further be capable of extracting information from the draft as will be explained later in detail. This may involve many operations in some cases, while in others this may be easy (for example in case of an html document which includes mark ups).

The first viewing unit 204, is in one embodiment the viewing unit of a reviewer. The second viewing unit 208 is in one embodiment the viewing unit of the drafter.

The first transmitting unit 203 may be adapted to transmit the transformed extracted data by email or by a file transfer according to FTP (file transfer protocol). In addition, also the second transmitting unit 207 may be adapted to transmit the edited transformed extracted data by email or by a file transfer according to FTP.

In the case of an email, the size of the attachments may be kept at minimum e.g. about 25 kB for every page of the draft to be revised compared to about 50 kB typically necessary for an image of a page of the draft. In a further embodiment the second format is a format compatible to word processing software, Internet browsing software, text viewing software, and/or image viewing software. Illustratively, the file containing the transformed extracted data can be displayed e.g. using Adobe Acrobat Reader, Microsoft Word, Microsoft Power Point, etc.

Similarly, the format of the edited transformed extracted data may be a format compatible to word processing software, Internet browsing software, text viewing software, and/or image viewing software. Additionally, the second format and/or the format of the edited transformed extracted data may be compressed formats such that a low amount of data has to be transmitted (to the benefit of the reviewers, in particular).

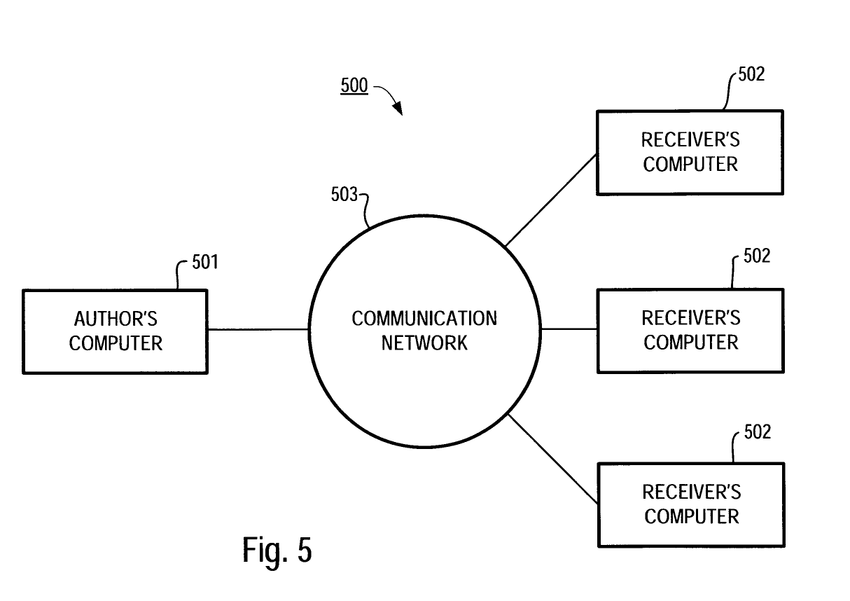

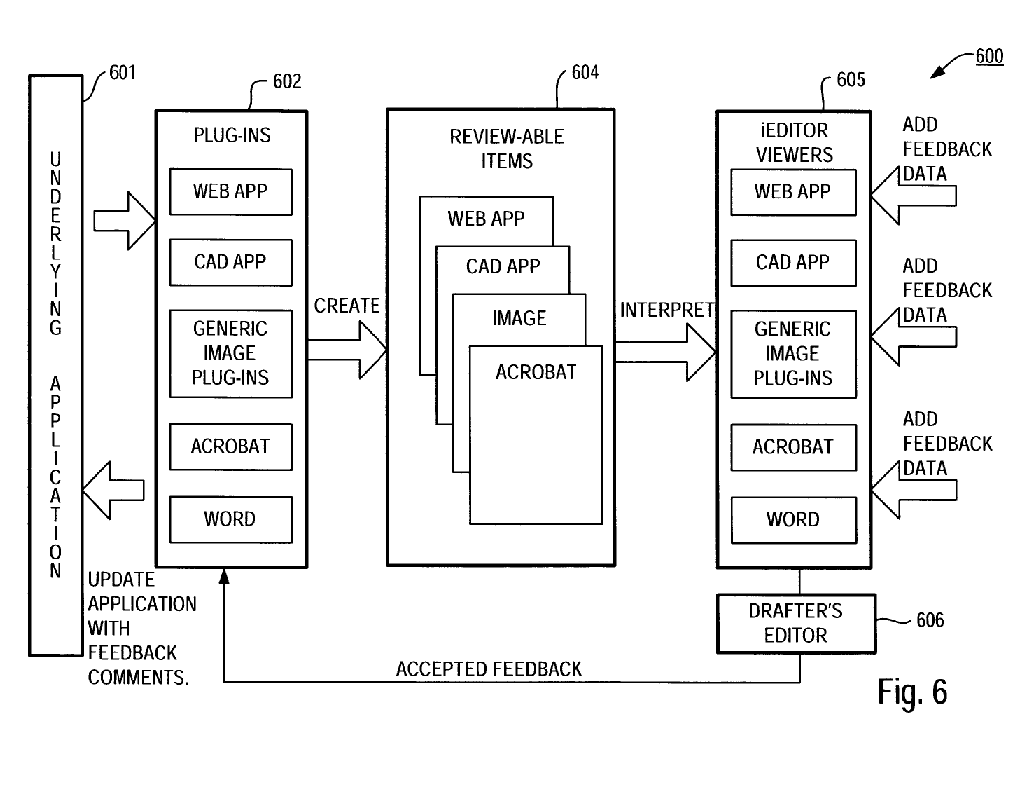

Illustrative embodiments are also explained in the following. The process of reviewing a draft according to one embodiment is explained with reference to FIG. 5 and FIG. 6.

FIG. 5 shows a system 500 according to an embodiment. The system 500 includes a computer 501 of an author and a plurality of reviewers' computers 502. The author's computer 501 and the plurality of reviewers' computers 502 are coupled by a communication network 503, which allows the transfer of data between the author's computer 501 and the plurality of reviewers' computers 502, for example by email or by a file transfer according to FTP (file transfer protocol).

FIG. 6 shows a flow diagram 600 according to an embodiment. The flow diagram includes an underlying application 601, plug-in computer programs 602, one or more review-able items 604 and a plurality of reviewers' editors 605. These elements and their interaction is described in detail in the following.

On the computer 501 of the author, an underlying application creating software is executed with which the author (drafter) creates the underlying application 601. The underlying application 601 is the draft requiring reviewing. The underlying application 601 can, for example, be a CAD drawing, a web application (like a website), a desktop application or an Adobe Acrobat document.

The plug-in computer programs 602 are provided in the software which is used to create the underlying application 601. The plug-in computer programs 602 are adapted to create the one or more review-able items 604 from the underlying application 601 in a suitable format (i.e. in a format understandable by an editor explained below). A review-able item is a part of the underlying application 601, which needs reviewing. For example, the underlying application 601 is a website and a review-able item 604 created by a plug-in computer program 602 from the underlying application 601 is the welcome page of the website.

A review-able item 604 can include multiple pages. Each page of a review-able item 604 is called a review-able page. After having been generated by the author's computer 501, the review-able items 604 are transmitted to the reviewers' computers 502 via the communication network 503 (see FIG. 5).

At the reviewers' computers 502, the review-able items 604 are interpreted by the plurality of reviewers' editors 605. On each of the reviewers' computers 502 a reviewers' editor 605 is executed which interprets the review-able items 604 and displays the review-able items 604 for the respective reviewer.

The reviewers' editors 605 have the capability to accept feedback from the reviewers. Further, they maintain a feedback history, i.e., such as storing information about the time and the order the feedback has been added to the review-able item.

The reviewers' editors 605 can be a viewing software providing editing functions, which can be enabled by clicking on an icon placed on a taskbar or a toolbar of the viewing software. When the editing functions are invoked, the reviewers' editors 605 can provide dialog boxes with which any modifications of the review-able item 604 can be carried out. The modifications, for example inserted comments and formatting, are tracked and stored. The tracking information is stored in a log file. When more than one reviewers are providing feedback, some prioritization for the feedback provided by the reviewers can be considered.

An author's editor 606 is executed on the author's computer 501. When all feedback has been added to the review-able items 604, the review-able items 604, now including feedback information, are sent back to the author's computer 501 via the communication network 503. The author's editor 606 executed on the author's computer 501 is adapted to consolidate the feedback information from the different reviewers. For example, comparing the feedback information from the different users and combining the feedback information.

The combination can be carried out according to priorities of the reviewers. For example, one reviewer might have the highest priority and therefore the feedback information provided by this reviewer is treated favourably in the course of the consolidation process. For example, if the feedback information provided by this reviewer contradicts another reviewer's feedback, it overrules the other reviewer's feedback and the other reviewer's feedback information is deleted.

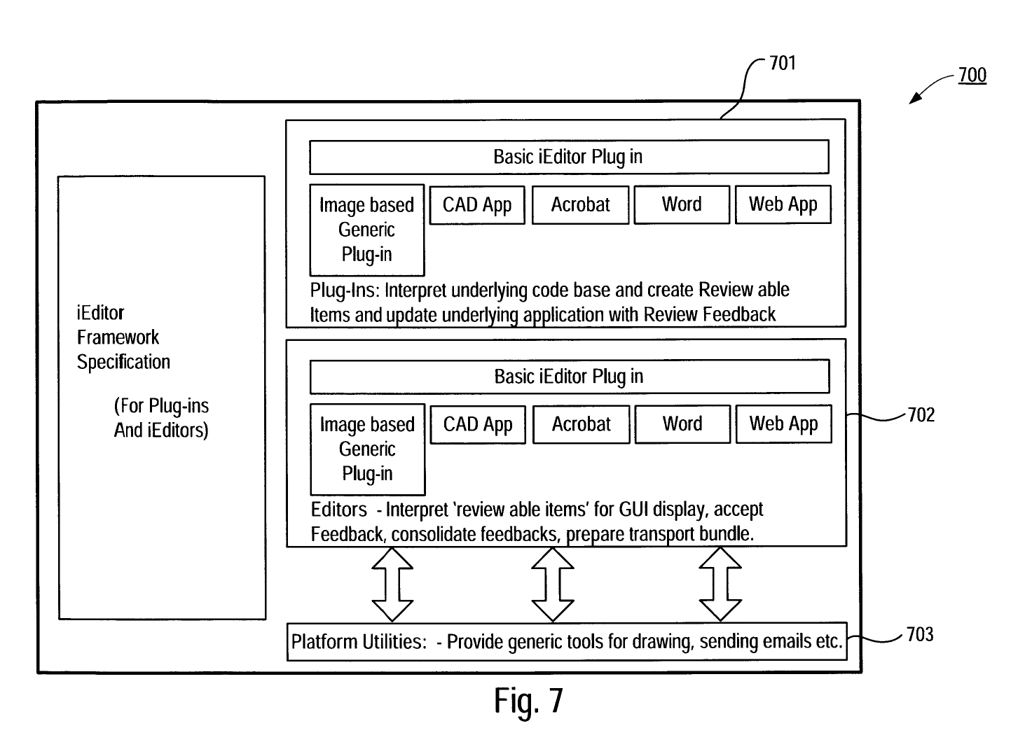

Once the feedback information is consolidated, the editor 606 of the author can be used to accept or reject the various feedback items. The editor 606 of the author can also be set to update the under-lying application 601 according to the accepted feedback information using an update function of the author's editor 606. Updating of the underlying application 601 is performed by a corresponding plug-in computer program 602. The architecture of the reviewing software used for the reviewing process is described in the following in details with reference to FIG. 7.

FIG. 7 shows a block diagram 700 illustrating a reviewing software architecture according to an. The architecture includes plug-ins 701, one or more editor programs 702 and platform utilities 703. These elements will be described in the following.

The block diagram 700 illustrates the architecture of the reviewing software, which is called iEditor (illustratively an intelligent editing software), used for the reviewing process. As explained with reference to FIG. 6, iEditor includes plug-ins 701 (corresponding to the plug-in computer programs 602 in FIG. 6) for the software with which the underlying application 601 is created. The plug-ins 701 interface with the underlying application creating software and with the underlying application 601 to perform operations like creating review-able items 604 and updating the underlying application 601 according to the feedback accepted by the author.

As explained above, iEditor further includes one or more editor programs 702 corresponding to the reviewers' editors 605 and the author's editor 606. Note that the reviewers' editors 605 can correspond to a first editor program of the editor programs 702 and the author's editor 606 to a second editor program of the editor programs 702. Also, the reviewers' editors 605 and the author's editor 606 can correspond to the same editor program of the editor programs 702.

The plug-ins 701 create the review-able items 604 from the underlying application 601 in a format that is understandable by the editor programs 702. This means that the format can be interpreted by the editor programs 702.

The editor programs 702 forms an interface between the users, i.e. the reviewers and the author, and iEditor. With help of the first editor program of the editor programs 702 (corresponding to the author's editor 606) the author can create review-able items 604 from the underlying application 601. For this, the first editor program of the editor programs 702 triggers the creation of a review-able item 604 by a corresponding plug-in 701. On the reviewer side, the second editor program of the editor programs 702 executed on the reviewers' computers 502 accepts the user feedback provided by the reviewers and maintains a feedback history.

When the feedback is sent to the computer 501 of the author, the author can accept or reject the feedback by using the first editor program of the editor programs 702. Further, the first editor program of the editor programs 702 provides facilities to consolidate the feedback as explained above. When the author decides to incorporate accepted feedback into the underlying application 601, he can use the first editor program of the editor programs 702 to export all accepted feedback data into a format that is understandable by one of the plug-ins 701. The accepted feedback is incorporated into the underlying application 601 by this plug-in.

For the purpose of sending review-able items 604 from the author's computer 501 to the reviewers' computers 502 and sending review-able items 604 including feedback from the reviewers' computers 502 to the author's computer 501, the editor programs 702 also have the functionality to create transport bundles from the corresponding files that can be sent across the communication network 503. This can be done by email or by another transmitting software, for example by an FTP (file transfer protocol) transfer software. The platform utilities 703 that can be used by the plug-ins 701 and the editor programs 702. The platform utilities 703 perform, for example, services for sending emails, saving and retrieving information from hard disc or floppy disc, etc.

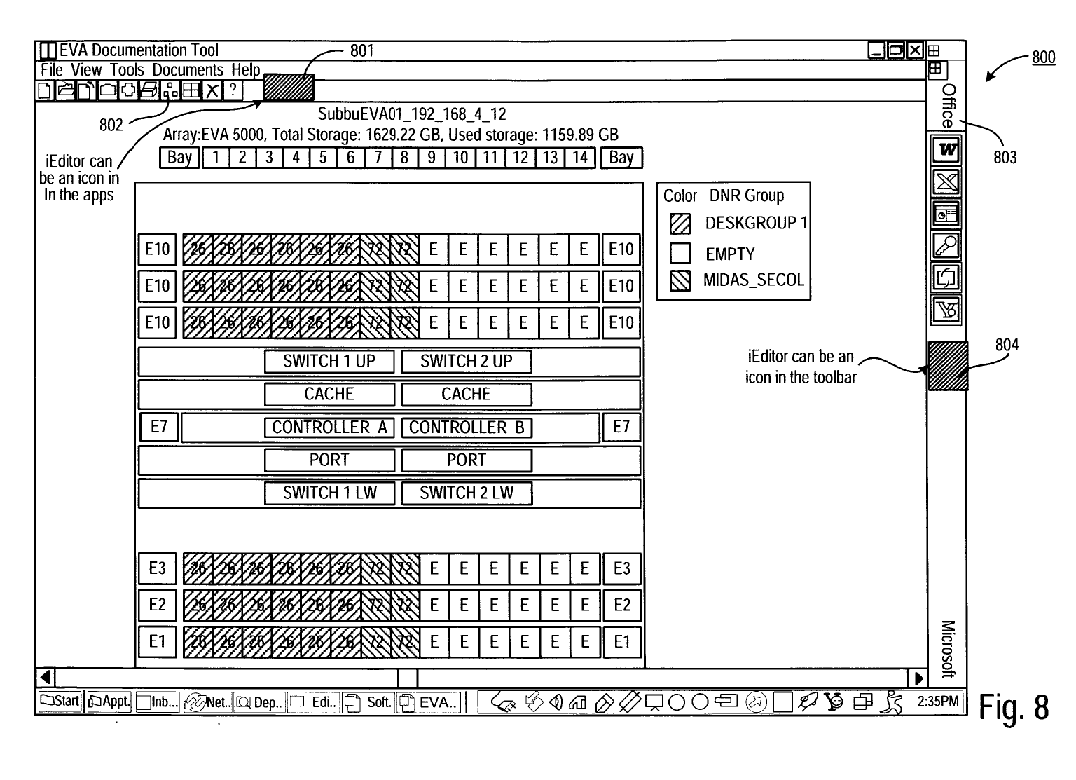

iEditor can be invoked using the software with which the underlying application 601 is created, as explained in the following with reference to FIG. 8. FIG. 8 shows a graphical user interface 800 of an underlying application creating software according to an embodiment.

The author creates the underlying application 601 using the underlying application creating software. The underlying application creating software that creates the underlying application 601 invokes iEditor when a corresponding icon is clicked upon. This icon can be provided by the graphical user interface (GUI) of the underlying application creating program itself and will thus be displayed for example on a first position 801 together with other icons 802 corresponding to other functions of the underlying application creating software.

Alternatively, the icon for invoking iEditor can be part of a tool bar displayed on the author's computer 501, in this case the Microsoft Office tool bar 803. As illustrated in FIG. 8, the icon for invoking iEditor is displayed on a second position 804. The icon placement can be achieved using a corresponding API (advanced programming interface).

When iEditor is invoked, review-able items from the underlying application 601 can be generated and sent to reviewers, for example by email using a custom compressed file format. iEditor can be provided with an icon which allows the author to directly send a file with review-able items as an email attachment to the intended recipients or reviewers.

A reviewer then uses the iEditor (i.e. the one of the editor programs 702 of iEditor) to open the received file and provide feedback on the review-able item. For this, the editor programs 702 include a rich tool bar containing options for marking, drawing, writing text, and adding images.

Once the reviewer has finished the modifications, he can disable the editing and tracking options by clicking on an icon provided by the editor program of the editor programs 702 he uses. Upon clicking on the icon, iEditor saves the modified review-able item, which also includes the tracking information about the modifications, in a suitable format which requires a low amount of disc space.

After the reviewers have input their feedback to iEditor, iEditor creates a file with a custom compressed file format and sends the feedback to the author. An option within Editor allows the reviewers to send the file as an attachment to the author. The format of the modified review-able item may be chosen such that the modified review-able item can be viewed by using commonly available applications like Internet Explorer or Adobe Acrobat Reader.

As mentioned above, the author can now accept or reject individual review comments of each of the reviewers. When the review comments have been accepted or rejected, iEditor can be instructed to consolidate the multiple feedbacks of the review-able item. In particular, iEditor provides an option for the author for viewing one feedback at a time or for merging all feedbacks from multiple reviewers in the review-able item.

Once iEditor has consolidated all the review comments (feedback from the reviewers) for the review-able item, the reviewing process described above can be repeated according to the author's wishes. That is, the consolidated list of review comments can be sent to all reviewers for further review. So, the consolidated list of review comments is a fresh review-able item.

In one embodiment, iEditor maintains the feedback history of a review-able item. This history for example includes for each feedback a specification of the reviewer who has provided the feedback and a date at which the reviewer has provided the feedback. As mentioned, once feedback is rejected, the feedback will not be maintain in the history anymore.

When a feedback is marked as accepted, the author can select an option of iEditor which allows to export the feedback to the underlying application 601. An export of the feedback to the underlying application 601 results in the underlying application 601 incorporating the feedback comments automatically, i.e., it is not necessary that the author manually changes the underlying application 301 to incorporate feedback into the underlying application 601.

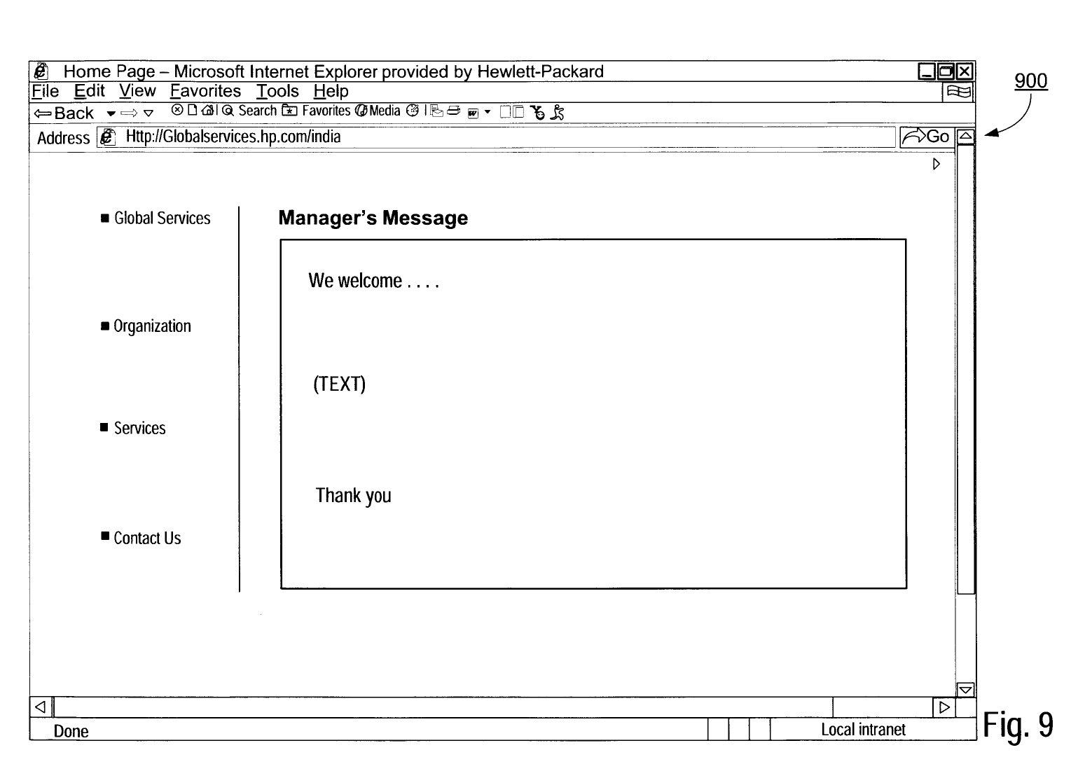

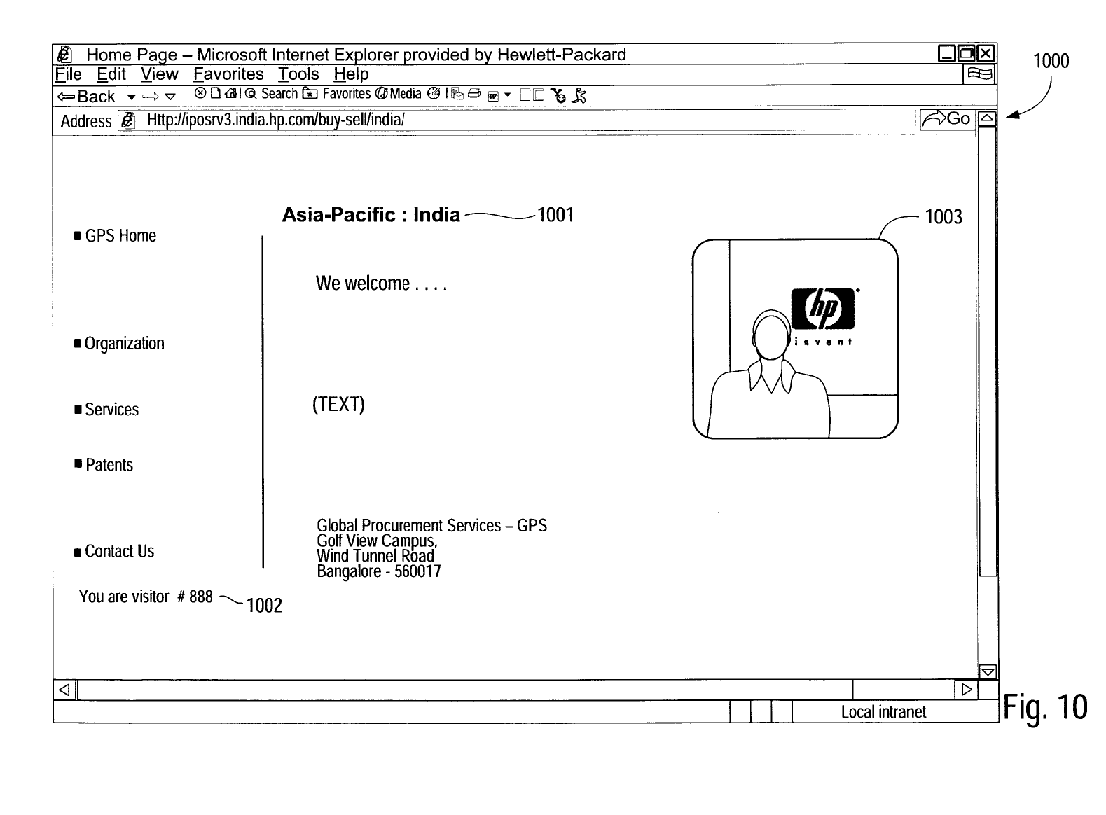

FIG. 9 shows a review-able item 900 according to an embodiment. In this example, the review-able item 900 is a web page, i.e. an internet page for the word wide web (WWW). Accordingly, the underlying application 601 is a website created with some software tool to create websites. As explained, the review-able item 900 is sent to reviewers who can include their feedbacks to the review-able item 900. The reviewers use iEditor to include modifications into the review-able item 900. An example for this is illustrated in FIG. 10.

FIG. 10 shows a modified review-able item 1000 according to an embodiment. The modified review-able item 1000 is based on the review-able item 900. In this example, the feedbacks from different reviewers have already been merged into one modified review-able item 1000.

A first reviewer has changed the heading 1001 and has included a counter 1002. A second reviewer has included a photo 1003. Other changes are visible and may have been included by further reviewers.

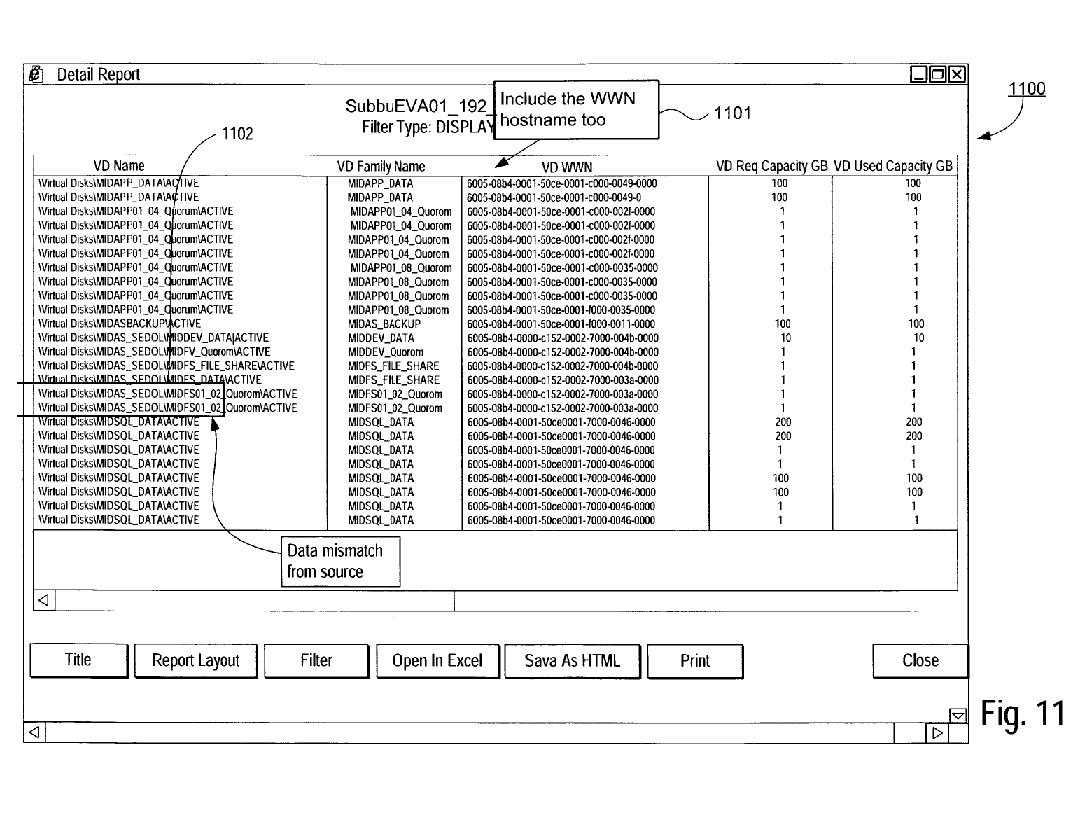

The author of the review-able item 900, i.e. the web page, can accept or reject the modification 1001, 1002, 1003. It is assumed that the author accepts all modifications 1001, 1002, 1003. Then, when the author selects a corresponding option of iEditor, the modifications 1001, 1002, 1003 are incorporated into the review-able item 900 such that the modified review-able item 1000 is the updated underlying application 601. Another example of a review-able item is shown in FIG. 11.

FIG. 11 shows a modified review-able item 1100 according to an embodiment. In this example, a reviewer has provided two comments 1101, 1102 in a review-able item, which is a screen shot of a Visual Basic-based client application. The reviewer provides the feedbacks that a host name has to be included in a certain column (corresponding to the first comment 1101) and that the data displayed is not matching with a source (corresponding to the second comment 1102).

iEditor sends the modified review-able item 1100 to the author's computer 501 for display to the author. The author can decide to change the underlying application according to the comments 1101, 1102.

In this case, the modified review-able item 1100 is based on a review-able item which is basically a screen shot of an application, i.e., a simple image. In the following, an embodiment will be described where a review-able item is an images or a set of images for every page of information that is to be reviewed.

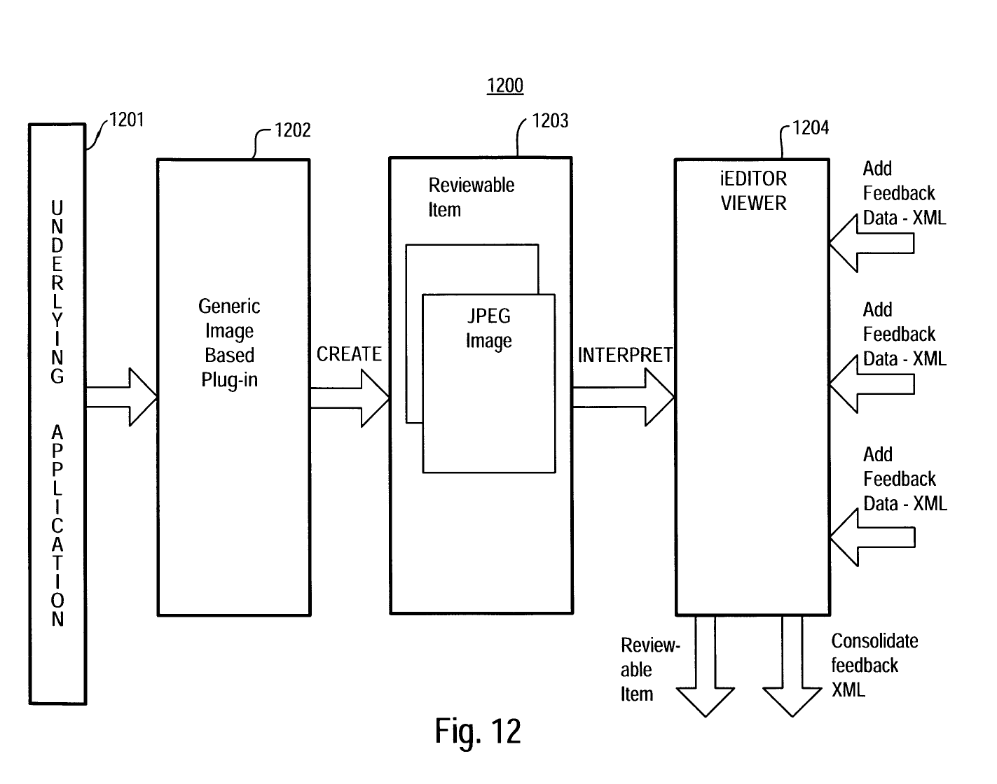

FIG. 12 shows a flow diagram 1200 according to an embodiment. Similar to the embodiment described above, an author creates an underlying application 1201 by using a corresponding underlying application creating software. In this embodiment, the software for creating the underlying application 1201 is provided with a generic image based plug-in 1202. The generic image based plug-in 1202 creates screen captures of every page of the underlying application 1201. The screen captures form the review-able items 1203. The review-able items 1203 are sent to reviewers' computers 502 where editors 1204 are executed which interpret the review-able items 1203, i.e., interpret the image data and display the corresponding images to the reviewers using an appropriate graphical user interface (GUI).

The editors 1204 are image based editors, display the review-able items 1203 and provide a rich toolbox to aid the reviewers in adding text, drawing lines, images, etc. as feedback data for the review-able items 1203. In this embodiment, the editors 1204 maintain the feedback data in XML format (extended mark up language). When the review-able items 1203 have been modified by the reviewers, i.e., when feedback has been added to the review-able items 903, the modified review-able items 1203 are sent to the author of the underlying application 1201.

The author also uses an editor 1204 which may be the same editor used by the reviewers or a different one and which has the capability to redraw all feedback data stored in XML format. Further, the editor 1204 used by the author has the ability to merge multiple XML files with feedback data to give a consolidated list of feedback data. As mentioned, iEditor captures all feedback information from the reviewers in XML format. The structure of the XML format is such that the feedback elements, for example boxes, lines, text etc. can be redrawn at any time over the review-able item. Thus, the feedback consolidation process becomes much simpler since it is basically an extension process, i.e., the process of retrieving feedback data from multiple XML files which are provided by different reviewers and of drawing over the review able item according to the XML files.

In particular, the transport bundles sent from the reviewers to the author include XML data. When the author receives the review feedback, iEditor simply reconstructs the feedback. That means that lines, text, images, etc. are added to the author's copy of the review-able item 903 according to the feedback.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A system for revising an electronic draft having a first format comprising:
an extraction unit adapted to extract a part of the data of the electronic draft requiring revision;
a transformation unit adapted to transform the extracted data into a second format;
a first transmitting unit adapted to transmit the transformed extracted data to a first viewing unit, wherein the first viewing unit is adapted to display the transformed extracted data;
an input unit adapted to receive revising input for revising the displayed transformed extracted data;
an editing unit adapted to edit the transformed extracted data according to the revising input;
a second transmitting unit adapted to transmit the edited transformed extracted data to a second viewing unit wherein the second viewing unit is adapted to display the edited transformed extracted data;
wherein
the first format is adapted such that the electronic draft can not be edited using the editing unit.

2. The system of claim 1, further comprising an updating unit adapted to update the electronic draft according to the revised portion of the electronic draft using the edited transformed extracted data.

3. The system of claim 1, wherein the extraction unit is a plug-in of a computer program with which the electronic draft can be edited.

4. The system of claim 1, wherein the extraction unit is a plug-in of a computer program with which the electronic draft can be created.

5. The system of claim 1, wherein the extraction unit is a plug-in of a computer program with which the electronic draft can be viewed.

6. The system of claim 1, wherein the first transmitting unit is adapted to transmit the transformed extracted data by email.

7. The system of claim 1, wherein the first transmitting unit is adapted to transmit the transformed extracted data by a file transfer according to FTP.

8. The system of claim 1, wherein the second transmitting unit is adapted to transmit the edited transformed extracted data by email.

9. The system of claim 1, wherein the second transmitting unit is adapted to transmit the edited transformed extracted data by a file transfer according to FTP.

10. The system of claim 1, wherein the second format is a format compatible to at least one word processing software, Internet browsing software, text viewing software, and/or image viewing software.

11. The system of claim 1, wherein the first format compatible to a software for creating the electronic draft.

12. A method for revising an electronic draft having a first format and requiring revision comprising the steps:
extracting a part of the data of the electronic draft;
transforming the extracted data into a second format;
transmitting the transformed extracted data to a first viewing unit;
displaying the transformed extracted data;
receiving revising input for revising the displayed transformed extracted data;
editing the transformed extracted data according to the revising input by an editing unit;
transmitting the edited transformed extracted data to a second viewing unit;
displaying the edited transformed extracted data;
wherein
the first format is adapted such that the electronic draft can not be edited using the editing unit.

13. (canceled)

14. (canceled)

15. A computer programmable medium having a program recorded thereon, which, when executed by a computer, makes the computer perform the following steps:
extracting a part of the data of an electronic draft having a first format and requiring revision;
transforming the extracted data into a second format;
transmitting the transformed extracted data to a viewing unit and an editing unit,
displaying the transformed extracted data;
receiving revising input for revising the displayed transformed extracted data;
editing the transformed extracted data according to the revising input;
transmitting the edited transformed extracted data to a second viewing unit;
displaying the edited transformed extracted data;
wherein
the first format is adapted such that the electronic draft can not be edited using the editing unit.

16. (canceled)

17. (canceled)

18. (canceled)
